(19) United States
(12) Patent Application Publication
(10) Pub. No.: US 2013/0283896 A1
(43) Pub. Date: Oct. 31, 2013

(54) SENSING DEVICE FOR CANISTERS

(71) Applicants: Naoki Matsuzawa, Saitama-shi (JP); Masaru Nakano, Sayama-shi (JP); Masaru Kurahashi, Ube-shi (JP); Kazuo Kayanuma, Gotemba-shi (JP); Makoto Tooyama, Fujiyoshida-shi (JP)

(72) Inventors: Naoki Matsuzawa, Saitama-shi (JP); Masaru Nakano, Sayama-shi (JP); Masaru Kurahashi, Ube-shi (JP); Kazuo Kayanuma, Gotemba-shi (JP); Makoto Tooyama, Fujiyoshida-shi (JP)

(73) Assignees: MAHLE FILTER SYSTEMS JAPAN CORPORATION, Tokyo (JP); ASAMA GOSEI COMPANY LIMITED, Yamanashi (JP); UBE INDUSTRIES, LTD., Ube-shi, Yamaguchi (JP)

(21) Appl. No.: 13/994,995

(22) PCT Filed: Dec. 16, 2011
(86) PCT No.: PCT/JP2011/079130

§ 371 Date: Jun. 17, 2013

(30) Foreign Application Priority Data
Dec. 22, 2010 (JP) 2010-285449

(51) Int. Cl. F02M 25/08

(52) U.S. Cl. CPC F02M 25/0854
USPC 73/114.39

(57) ABSTRACT

Sensing device for canister has canister sensor 40 that detects state of activated carbon 10 filling an inside of casing 11 of the canister. Peripheries of temperature sensing element 51 and current application unit of the canister sensor 40 which are arranged in the casing 11 are covered in non-conductive thick insulating material 54. Root portion 56, which is covered in the insulating material 54, of heat transfer plate 55 having high heat conductivity is arranged with the root portion 56 being adjacent to the temperature sensing element 51, in order to increase sensor sensitivity by increasing heat transfer. Top end portion 57, which protrudes from the insulating material 54, of the heat transfer plate 55 is exposed to the inside of the casing 11. Insulating layer 63 is formed at least on surface of the root portion 56 of the heat transfer plate 55 by surface treatment.

### TECHNICAL FIELD

The present invention relates to a sensing device for a canister that has a canister sensor detecting a state of an adsorbent that fills an inside of a casing of the canister.

### BACKGROUND ART

Patent Document 1 discloses an example of a sensor for a canister, which detests states of heat capacity and temperature etc. of an adsorbent such as an activated carbon that fills an inside of a casing of the canister. A temperature sensing element (a heating part) of this sensor and a part of a current application unit such as an electrode and a wire that supply current to this temperature sensing element are arranged in the canister casing filled with the activated carbon. Because of this, in such a case that a coating or a covering of the current application unit is damaged, for instance, due to deterioration with time, there is a risk that the current application unit will be exposed then an electric leak or a spark will occur. Thus, as illustrated in FIG. 2 of Patent Document 2, a periphery of each of the temperature sensing element and the current application unit arranged in the canister casing might be covered with a non-conductive thick insulating material such as synthetic resin material.

### CITATION LIST

### Patent Document

Patent Document 1: Japanese Patent Provisional Publication Tokkai No. 2010-106664

Patent Document 2: Japanese Utility Model Provisional Publication Jikkaihei No. 4-40146

### SUMMARY OF THE INVENTION

### Technical Problem

However, if the periphery of the temperature sensing element is covered with the thick insulating material, since heat transfer (or heat transmission) between the temperature sensing element and the adsorbent issuppressed•lessened, a sensor sensitivityis lowered. Further, because the temperature sensing element such as a thermistor is generally small, the heat transfer between the temperature sensing element and the adsorbent tends to be inadequate.

### Solution to Problem

The present invention was made in light of such circumstances. That is, a sensing device for a canister according to the present invention has a canister whose casing is filled with an adsorbent to adsorb an evaporated fuel; and a canister sensor that detects a state of the adsorbent filling an inside of the casing of the canister. The canister sensor has a temperature sensing element; a current application unit that applies current to the temperature sensing element; a non-conductive insulating material that covers peripheries of the temperature sensing element and the current application unit which are arranged in the casing; and a heat transfer plate that is formed by metal material such as aluminum alloy and has a heat conductivity that is higher than at least that of the insulating material. A root portion, which is covered in the insulating material, of one end side of the heat transfer plate is arranged with the root portion being adjacent to the temperature sensing element, and a top end portion, which protrudes from the insulating material, of the other end side of the heat transfer plate is exposed to the inside of the casing filled with the adsorbent.

The canister sensor of the present invention is a so-called active sensor, like a temperature sensor using e.g. a thermistor, in which current or voltage is applied by an external power supply. Because of this, if the temperature sensing element and its current passing part which are arranged in the casing are exposed to the inside of the casing, there is a risk that an electric leak or a spark will occur. Thus, in the present invention, peripheries of the temperature sensing element and the current application unit arranged in the casing are covered with (or in) the non-conductive thick insulating material.

However, if the periphery of the temperature sensing element is covered with such thick insulating material, the heat transfer between the temperature sensing element and the adsorbent is decreased, and the sensor sensitivity is lowered. Thus, in the present invention, the heat transfer plate that is formed by metal material such as aluminum alloy and has high heat conductivity is provided. Regarding this heat transfer plate, the root portion, which is buried in the insulating material, of the heat transfer plate is arranged with the root portion being adjacent to the temperature sensing element, and the top end portion, which protrudes from the insulating material, of the heat transfer plate is exposed to the inside of the casing. Therefore, the heat transfer plate is in contact with or touches the adsorbent filling the inside of the casing. Good heat transfer between the adsorbent and the temperature sensing element is thus secured through the heat transfer plate.

It is preferable that a pair of the heat transfer plates be provided so as to sandwich the temperature sensing element, and a space between a pair of the top end portions, which are exposed to the inside of the casing, of the heat transfer plates be wide as compared with that of the root portion.

It is also preferable that the heat transfer plate be provided with at least one of a plurality of penetration holes and a plurality of uneven parts.

Further, it is preferable that a sensor unit having, as the canister sensor, a heat capacity sensor that detects a heat capacity of the adsorbent and a temperature sensor that detects a temperature be fixed to a side wall of the casing of the canister, the heat capacity of the adsorbent be detected on the basis of an output voltage or an output current of the temperature sensing element in a state in which the temperature sensing element of the heat capacity sensor is heated by the current application, and the heat capacity be corrected according to the temperature detected by the temperature sensor, and in order that a temperature increase, due to the heat generation, of the heat capacity sensor is not detected by the temperature sensor, a predetermined space be secured between the heat transfer plate of the heat capacity sensor and the heat transfer plate of the temperature sensor.

Further, it is preferable that the heat transfer plate be formed by metal material, and an insulating layer be formed at least on a surface of the root portion of the metal heat transfer plate by surface treatment.

The canister sensor is a sensor that detects a state of an adsorbent that adsorbs an evaporated fuel filled in a casing of a canister. The canister sensor has a temperature sensing element; a current application unit that applies current to the temperature sensing element; anon-conductive insulating material that covers peripheries of the temperature sensing element and the current application unit which are arranged in the casing; and a heat transfer plate having a heat conductivity that is higher than at least that of the insulating material. A root portion, which is covered in the insulating material, of one end side of the heat transfer plate is arranged with the root portion being adjacent to the temperature sensing element, and a top end portion, which protrudes from the insulating material, of the other end side of the heat transfer plate is exposed to an inside of the casing filled with the adsorbent.

As the temperature sensing element of the canister sensor, it is preferable to use an NTC ceramic element that has such negative characteristic that a resistance of the element decreases with increase of a temperature.

It is preferable that B constant (B_{25/85}) which indicates magnitude of change of resistance value, of the NTC ceramic element be 3500˜5500 K (Kelvin). If the B constant is smaller than 3500 K, detection sensitivity of the ceramic element becomes worse, and if the B constant is greater than 5500 K, the detection becomes impossible in a lower temperature range. This B constant (B_{25/85}) is a value calculated from a zero load resistance value (R25 and R85) of the thermistor which is measured at reference temperatures 25° C. and 85° C. As an expression for calculation of the B constant, “B_{25/85}=(lnR25−lnR85)/[1/(273.15+25)−1/(273.15+85)]” is used.

### Effects of the Invention

According to the present invention described above, since the peripheries of the temperature sensing element and the current application unit arranged in the casing are covered with or in the insulating material, it is possible to surely prevent the current passing part from being exposed to the inside of the casing filled with the adsorbent, then the occurrences of the electric leak and the spark can certainly be avoided. In addition, the heat transfer plate having the high heat conductivity facilitates the heat transfer between the activated carbon and the temperature sensing element, and the sensor sensitivity can be increased.

### BRIEF DESCRIPTION OF THE DRAWINGS

[FIG. 1]

FIG. 1 is a system block diagram showing a sensing device for a canister according to a first embodiment of the present invention.

[FIG. 2]

FIG. 2 is a sectional view of the canister of FIG. 1

[FIG. 3]

FIG. 3 is a sectional view taken along a line A-A in FIG. 2.

[FIG. 4]

FIG. 4 is an enlarged sectional view of a temperature sensing element etc. of FIG. 3.

[FIG. 5]

FIGS. 5A and 5B are a plan view (5A) and a side view (5B), showing a heat transfer plate according to a second embodiment of the present invention.

[FIG. 6]

FIGS. 6A and 6B are a plan view (6A) and a side view (6B), showing a heat transfer plate according to a third embodiment of the present invention.

[FIG. 7]

FIG. 7 is a system block diagram showing a sensing device for the canister according to a fourth embodiment of the present invention, which corresponds to a sectional view taken along the line A-A in FIG. 2.

### EMBODIMENTS FOR CARRYING OUT THE INVENTION

In the following description, embodiments of the present invention will be explained with reference to the drawings.

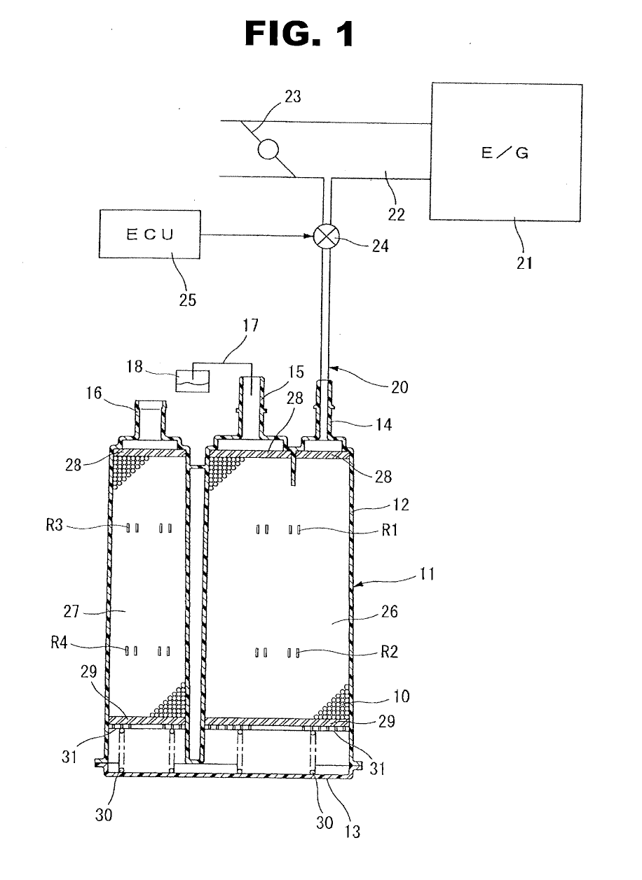

FIG. 1 is a system block diagram showing a sensing device for a canister according to a first embodiment of the present invention. A box-shaped synthetic resin casing 11 of the canister is filled with an activated carbon 10 as an adsorbent that adsorbs evaporated fuel (or evaporative fuel). This casing 11 is formed by a body 12 whose one end is open and a cover 13 which closes this opening end of the body 12. A U-turn-shaped gas passage is formed in the casing 11, and a purge port 14 and a charge port 15 are provided at one end side of this gas passage. An air port 16 that opens to an atmosphere is provided at the other end side of the gas passage. The charge port 15 is connected to a fuel tank 18 of a vehicle through a charge line (a charge pipe) 17. The purge port 14 is connected to an intake passage 22 of an internal combustion engine 21 through a purge line (a purge pipe) 20, more specifically, the purge port 14 is connected to a downstream position of a throttle valve 23 that controls an intake air. The purge line 20 is provided with a purge control valve 24. An operation of this purge control valve 24 is controlled by a control unit 25 that is capable of storing and performing each control of the engine.

In the casing 11, a first adsorption chamber 26 in which the activated carbon 10 is filled is formed in a longitudinal direction side passage, at a charge•purge port side, of the U-turn-shaped gas passage. A second adsorption chamber 27 in which the activated carbon 10 is filled is formed in a longitudinal direction side passage at an air port side. Both ends of each of the first and second adsorption chambers 26 and 27 are partitioned or defined by plate-shaped filter members 28 and 29 having air permeability, and these filtermembers 28 and 29 prevent the activated carbon 10 from falling out. Further, at a turn-up part, at a cover 13 side, of the U-turn-shaped gas passage, two springs 30 are set between an inner surface of the cover 13 and a perforated plate 31 having air permeability with the two springs 30 compressed. The activated carbon 10 in the first and second adsorption chambers 26 and 27 is then kept in a predetermined filling state by spring forces of these springs 30.

When manufacturing this canister, the filter member 28, the activated carbon 10, the filter member 29, the perforated plate 31 and the springs 30 are installed from the opening end of the body 12 in this order, then lastly, the cover 13 is connected to the body 12 so as to close the opening end of the body 12.

The evaporated fuel generated in the fuel tank 18 is introduced into an inside of the casing 11 by the charge port 15 through the charge line 17, and is adsorbed by the activated carbon 10 that fills this inside of the casing 11, then is temporarily trapped (or caught)•charged. Afterwards, by opening the purge control valve 24 during a certain operating state of the internal combustion engine 21, purge of the evaporated fuel that is charged in the casing 11 is started. During execution of this purge, an atmospheric air is introduced into the casing 11 from the air port 16 by a pressure difference between a negative pressure at the downstream side of the throttle valve 23 in the intake passage 22 and an atmospheric pressure, thereby releasing, namely, purging the evaporated fuel adsorbed in the casing 11. Purge gas including this released evaporated fuel is supplied to the intake passage 22 from the purge port 14 through the purge line 20, then is burned in a combustion chamber of the internal combustion engine 21.

As shown in FIG. 3, a sensor unit 41 having a pair of canister sensors 40 (40A, 40B) that are arranged parallel to each other at a predetermined distance is fixed at a side wall 11A of the casing 11. This sensor unit 41 has a fixing bracket 42 that holds a pair of the canister sensors 40. The fixing bracket 42 is fixed to the casing side wall 11A by the fact that a nut 44 is screwed onto a top end of a screw portion 43 that penetrates the casing side wall 11A. Between the casing side wall 11A and a flange portion 45 that overhangs outwards from a side of the fixing bracket 42, an O-ring 46 to seal a gap between these casing side wall 11A and flange portion 45 is set.

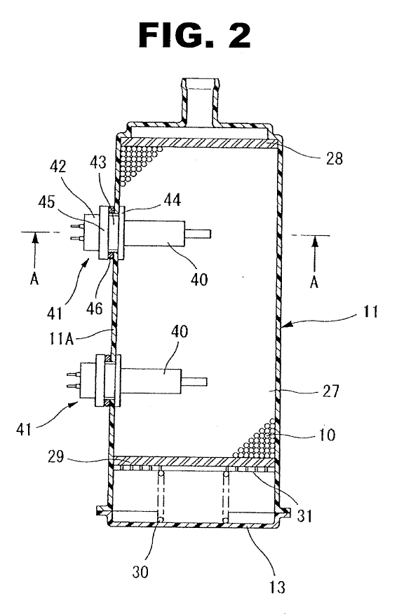

This sensor unit 41 is set at a required detection position. For instance, as shown in FIG. 1, the sensor unit(s) 41 is (are) set at any one or a plurality of positions of a charge•purge port side position R1 in the first adsorption chamber 26, a drain port side position R2 in the first adsorption chamber 26, a drain port side position R3 in the second adsorption chamber 27 and a charge•purge port side position R4 in the second adsorption chamber 27. As an example, in FIG. 2, the sensor units 41 are set at two positions R3 and R4 in the second adsorption chamber 27.

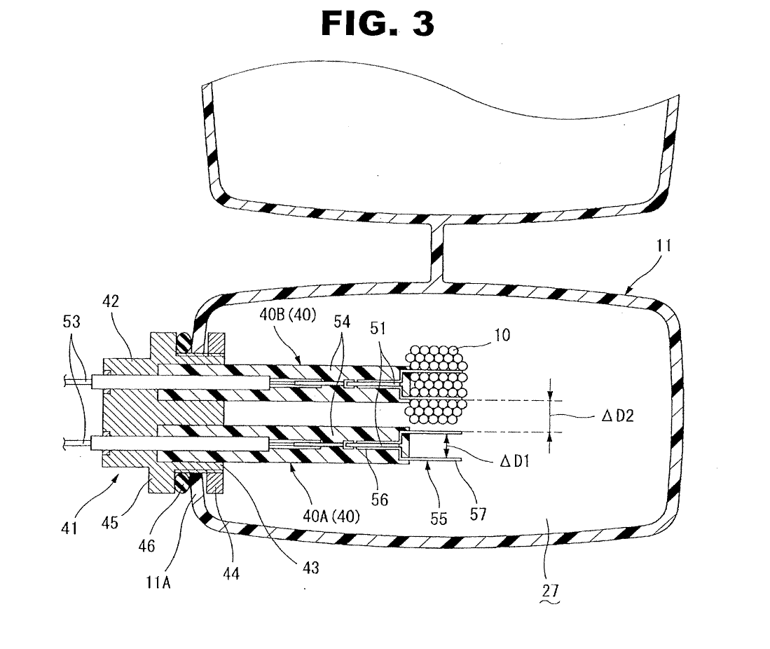

A pair of the canister sensors 40 attached to one sensor unit 41 is the same as that disclosed as a second embodiment shown in FIGS. 3 and 4 in the above Japanese Patent Provisional Publication Tokkai No. 2010-106664. This will be explained briefly. The canister sensor 40 is formed by a heat capacity sensor 40A that detects a heat capacity of the activated carbon 10 (the adsorbent) and a temperature sensor 40B that detects a surrounding temperature (a temperature around the temperature sensor 40B).

Regarding the heat capacity sensor 40A, current (or voltage) is applied to a temperature sensing element (a temperature-sensitive element) 51 such as a thermistor whose resistance value changes according to the temperature, then the temperature sensing element 51 is heated. On the other hand, the temperature of the temperature sensing element 51 lowers by the fact that the temperature sensing element 51 loses the heat by the evaporated fuel including hydrocarbon (HC) that is adsorbed by the activated carbon 10. Thus, by detecting an output voltage (or an output current) of the temperature sensing element 51 by the control unit 25, the heat capacity of the evaporated fuel can be detected•estimated from this output voltage.

As the temperature sensing element 51, in the present embodiment, NTC ceramic element having such negative characteristic that a resistance of the element decreases with increase of the temperature is used. With regard to this NTC ceramic element, its B constant (B₂₅/₈₅) which indicates magnitude of change of resistance value is 3500˜5500 K (Kelvin). The reason why this NTC ceramic element is used is because if the B constant is smaller than 3500 K, detection sensitivity of the ceramic element becomes worse, and if the B constant is greater than 5500 K, the detection becomes impossible in a lower temperature range. Here, the B constant (B_{25/85}) is a value calculated from a zero load resistance value (R25 and R85) of the thermistor which is measured at reference temperatures 25° C. and 85° C. As an expression for calculation of the B constant, “B₂₅/₈₅=(lnR25−lnR85)/[1/(273.15+25)−1/(273.15+85) ]” is used.

The output voltage of the heat capacity sensor 40A changes also by the surrounding temperature. Therefore, the output voltage of the heat capacity sensor 40A, namely, the heat capacity of the evaporated fuel, is corrected or compensated according to the temperature detected by the temperature sensor 40B. With respect to this temperature sensor 40B, by setting the current application to the temperature sensing element 51 and the heat generation of the temperature sensing element 51 to be extremely small, from its output voltage (the output current), the surrounding temperature can be estimated. From the heat capacity of the evaporated fuel detected and corrected in this manner, by referring to a previously adjusted setting table or map, it is possible to predict an adsorption amount of the evaporated fuel, and also predict a concentration of the evaporated fuel in the purge gas supplied to the intake passage side from the canister. This evaporated fuel concentration is used, for instance, for correction of a fuel injection amount by feedback control of air-fuel ratio and/or correction of opening of the purge control valve 24.

Next, a structure of the canister sensor 40, which is a main part of the present embodiment, will be explained with reference to FIG. 4. In this embodiment, the heat capacity sensor 40A and the temperature sensor 40B employ the same structure.

The canister sensor 40 is a so-called active sensor in which the current (the voltage) is applied to the temperature sensing element 51 by an external power supply in order to detect the resistance change, due to the temperature, of the temperature sensing element 51. As the temperature sensing element 51, the thermistor etc., which generate the heat by the current application and whose resistance value changes according to the temperature, are used.

As a current application unit to apply the current (the voltage) to this temperature sensing element 51, a pair of silver electrodes 52 that sandwich both side surfaces of the plate-shaped temperature sensing element 51 are provided. Each silver electrode 52 is supplied with power from the external power supply through a current (or voltage) application line 53 (see FIG. 3). As an electrode protection coating (or covering), a thin film resin coating layer 52A is formed on a surface of the silver electrode 52.

Peripheries of the temperature sensing element 51 and the silver electrode (the current application unit) 52 that are arranged inside the casing 11 are covered•molded with a non-conductive thick insulating material 54. That is, the temperature sensing element 51 and the silver electrode 52 arranged inside the casing 11 are completely buried in the insulating material 54 without being exposed to the outside. This insulating material 54 is formed by a synthetic resin material having high electrical insulation performance and high strength.

Further, in the present embodiment, a pair of heat transfer plates 55 are provided. The heat transfer plate 55 is formed by metal material such as aluminum alloy, which has high heat conductivity, great corrosion resistance and high durability and whose heat capacity is small and which is a low-cost material. As thin the heat transfer plate 55 as possible is most favorable.

A root portion 56, which is buried•covered in the insulating material 54, at one end side of the heat transfer plate 55 is arranged with the root portion 56 being adjacent to or adjoining the temperature sensing element 51. On the other hand, a top end portion 57, which protrudes from the insulating material 54, at the other end side of the heat transfer plate 55 is exposed to the inside of the casing 11 and is in contact with or touches the activated carbon 10 filling the inside of the casing 11.

More specifically, each root portion 56 of a pair of the heat transfer plates 55 is stuck to an outer side surface of the resin coating layer 52A of the silver electrode 52 through a thin film adhesive layer 59 so as to sandwich a pair of silver electrodes 52.

The adhesive layer 59 is formed by material such as silicon-base adhesive, which has high heat conductivity in order not to hinder the heat transfer between the temperature sensing element 51 and the heat transfer plates 55 and also has good electrical insulation performance in order that an electric leak or a spark does not occur. In order for the heat transfer between the temperature sensing element 51 and the heat transfer plates 55 to be increased, this adhesive layer 59 is set to be as thin as possible, also the adhesive layer 59 is set so that its contact area becomes wide. Thus, as shown in FIG. 4, a top end portion of the canister sensor 40 has a layer structure in which the silver electrode 52, the resin coating layer 52A, the adhesive layer 59 and the root portion 56 of the heat transfer plate 55 are arranged in layers at both sides of the plate-shaped temperature sensing element 51.

The top end portion 57 of the heat transfer plate 55 is formed stepwise to be bent outwards through a bending portion 58 so that a space AD1 between a pair of the top end portions 57 of the heat transfer plate 55 is wide as compared with that of the root portion 56. This space ΔAD1 of the top end portion 57 between a pair of the heat transfer plates 55 is set to be adequately greater than at least a diameter of the activated carbon 10 so that the activated carbon 10 surely enters or penetrates to an inside of the space ΔD1 then good contact with the heat transfer plate 55, i.e. good heat transfer, is ensured.

According to the present embodiment described above, by the non-conductive thick insulating material 54, it is possible to surely prevent the temperature sensing element 51 and the current application unit arranged inside the casing 11 from being exposed to the inside of the casing 11, thereby certainly suppressing the occurrences of the electric leak and the spark. And also, by the heat transfer plate 55, it is possible to facilitate the heat transfer between the activated carbon 10 and the temperature sensing element 51, thereby increasing the sensor sensitivity. As a consequence, a detection accuracy of the heat capacity of the evaporated fuel, detected by the canister sensor 40, can be increased, which therefore increases a prediction accuracy of the concentration of the evaporated fuel in the purge gas, which is predicted from this heat capacity.

Further, since the heat transfer plate 55 has the plate shape, an area where the heat transfer plate 55 is adjacent to or adjoins the temperature sensing element 51 is secured wide, thereby increasing the heat transfer. For instance, as compared with a tubular metal protection sheath, working process is easy and simple, and production flexibility is also increased. For this reason, as described above, it is possible to readily obtain the bending structure of the top end portions 57 whose space is wider than that of the root portion 56.

Furthermore, since the heat capacity sensor 40A and the temperature sensor 40B are formed as one unit of the sensor unit 41, as compared with a case where each sensor is installed in the casing 11, its installation work or operation becomes easy, and also it is possible to arrange the both heat capacity sensor 40A and temperature sensor 40B so as to secure a proper positioning relationship with stability.

More specifically, as shown in FIG. 3, in order that a temperature increase, due to the heat generation, of the heat capacity sensor 40A is not detected by the temperature sensor 40B, a predetermined space ΔD2 (see FIG. 3) is secured between the heat transfer plate 55 of the heat capacity sensor 40A and the heat transfer plate 55 of the temperature sensor 40B. It is therefore possible to suppress•avoid a decrease in the detection accuracy of the temperature detected by the temperature sensor 40B which is caused by receiving the temperature due to the heat generation of the heat capacity sensor 40A.

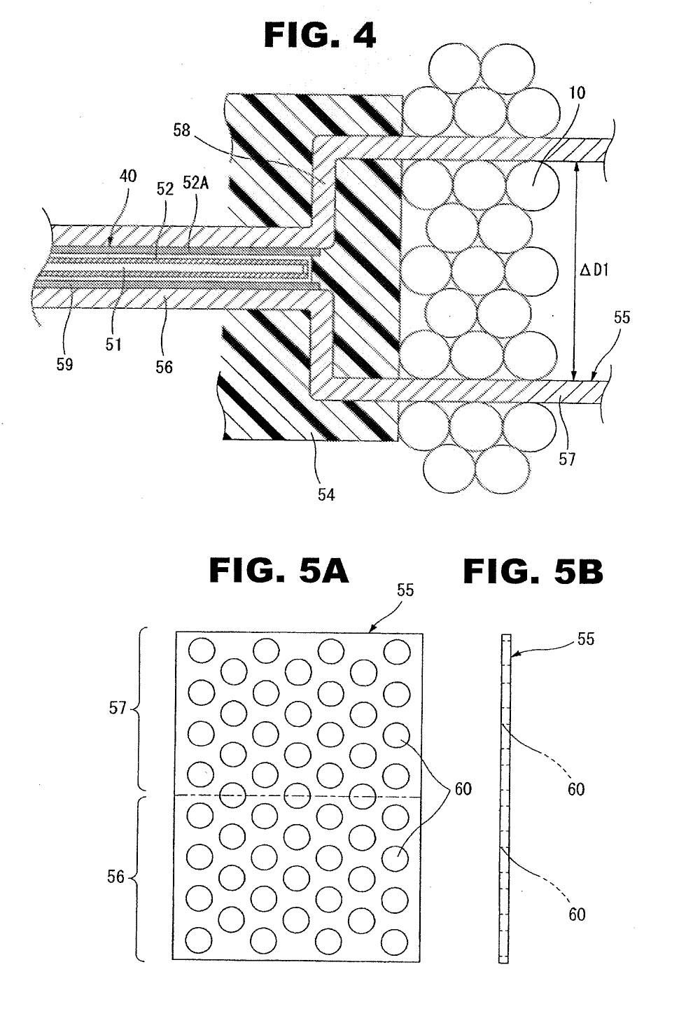

In a second embodiment shown in FIGS. 5A and 5B, a number of penetration holes 60 are formed from the root portion 56 to the top end portion 57 of the heat transfer plate 55. In this case, since a part of the activated carbon 10 enters or is fitted to this penetration hole 60 around the top end portion 57 that is exposed to the inside of the casing 11, a filling efficiency of the activated carbon 10 around the heat transfer plate 55 is increased. Also, since the contact area between the activated carbon 10 and the heat transfer plate 55 is increased, the heat transfer can be enhanced, which therefore further increases the sensor sensitivity.

Moreover, as for the root portion 56 buried in the insulating material 54, by forming the penetration holes 60, an adhesive strength by the adhesive layer 59 is increased. In addition, air is vented or expelled through these penetration holes 60, this thus brings about an increase in the sensor sensitivity.

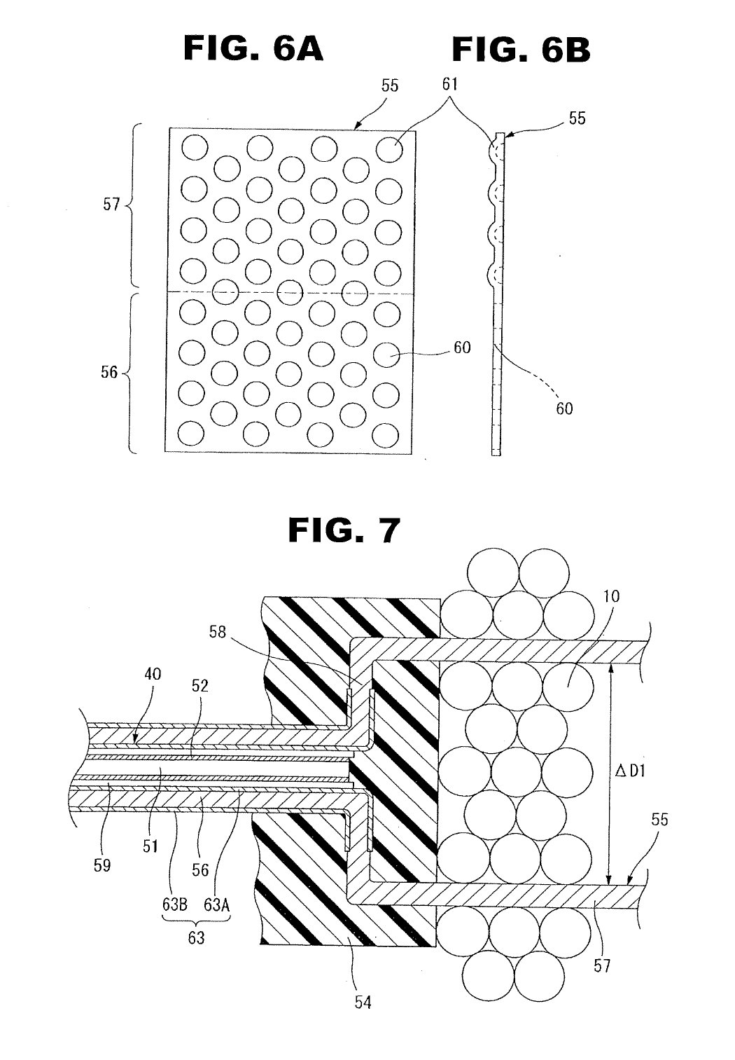

In a third embodiment shown in FIGS. 6A and 6B, the top end portion 57, exposed to the inside of the casing 11, of the heat transfer plate 55 is provided with a number of embossed portions 61 that bulge or swell in a direction orthogonal to the surface of the top end portion 57. That is, a number of uneven parts are formed on the heat transfer plate 55 by the embossed portions 61. Therefore, the uneven parts by the embossed portions 61 allow a rigidity of the top end portion 57 of the heat transfer plate 55 to be increased, and thus deformation or breakage of the heat transfer plate 55 can be suppressed. Further, since the contact area between the activated carbon 10 and the heat transfer plate 55 is increased, as same as the second embodiment, the heat transfer can be enhanced, which therefore further increases the sensor sensitivity.

As for the root portion 56, as same as the second embodiment, a number of the penetration holes 60 are provided in the root portion 56, and the same function and effect as those of the second embodiment can be obtained.

FIG. 7 is a sectional view of a sensing device for the canister according to a fourth embodiment of the present invention. In this fourth embodiment, as same as the first embodiment shown in FIG. 4, the silver electrodes 52 are provided at the both side surfaces of the temperature sensing element 51, and each silver electrode 52 is supplied with power from the external power supply through the current (or voltage) application line 53. The surface of the silver electrode 52 is bonded to the root portion 56 of the heat transfer plate 55 through the adhesive layer 59 that is applied to an area (the surface of the silver electrode 52 or the root portion 56) except a connecting portion with the current application line 53.

Further, in this fourth embodiment, in comparison with the first embodiment shown in FIG. 4, the resin coating layer 52A to coat the surface of the silver electrode 52 is eliminated. Instead, an insulating layer 63 (63A, 635) is formed at least on the surface of the root portion 56 of the metal heat transfer plate 55 by surface treatment. That is, in the first embodiment shown in FIG. 4, the silver electrode 52 and the heat transfer plate 55 are isolated each other by double-insulation of the resin coating layer 52A and the adhesive layer 59 (the silicon-base adhesive), whereas in the fourth embodiment shown in FIG. 7, the silver electrode 52 and the heat transfer plate 55 are isolated each other by double-insulation of the adhesive layer 59 and the insulating layer 63.

More specifically, the heat transfer plate 55 is formed by aluminum alloy (aluminium alloy) having, as a main ingredient, aluminum which is lightweight and low-cost material. Then, by performing electrolysis (anodic oxidation) with this aluminum alloy heat transfer plate 55 being an anode, an aluminium oxide coating, i.e. the insulating layer 63 that is an anodized aluminum layer, is formed on the surface of the heat transfer plate 55.

This insulating layer 63 is formed at least at a side surface part (63A) of an inner side of the root portion 56 that is adjacent to or adjoins the silver electrode 52 through the adhesive layer 59, of the heat transfer plate 55. In the fourth embodiment shown in FIG. 7, the insulating layer 63 is provided at both side surface parts (63A, 63B) of the heat transfer plate 55 throughout a range from the root portion 56 to a part of the bending portion 58. On the other hand, the top end portion 57, which faces the adsorption chamber filled with the activated carbon (the adsorbent) 10 in the casing 11, of the heat transfer plate 55 is not provided with the insulating layer 63 by masking etc. upon the surface treatment.

As described above, in the present embodiment, ease of the masking process when carrying out the surface treatment is taken into consideration, and the both side surfaces (63A, 63B) of the heat transfer plate 55 are provided with the insulating layer 63. Further, a boundary of presence/absence of the insulating layer 63 is provided at the bending portion 58, and the insulating layer 63 is not provided at the top end portion 57 of the heat transfer plate 55 on purpose to secure the heat transfer between the top end portion 57 and the activated carbon 10.

In the case, like the first embodiment shown in FIG. 4, where the surface of the silver electrode 52 is coated with the resin coating layer 52A, the thicker the thickness (film thickness) of the resin coating layer 52A, the lower the heat conductivity. Thus, as thin the film thickness as possible is most favorable.

On the other hand, the temperature sensing element 51 such as the thermistor, which is coated with the resin coating layer 52A through the silver electrode 52, is formed, for instance, by compacting powder. For this reason, it is difficult to form a flat mating or bonding surface. Therefore, in the case where the resin coating layer 52A is thin, there is a possibility that the resin coating layer 52A will tear or be damaged. When attempting to obtain high insulation performance and high reliability, it is required to form the resin coating layer 52A thick. However, if the resin coating layer 52A is set to be thick, the heat transfer becomes low. It is thus difficult to satisfy both of the insulation performance and the heat transfer.

In contrast to this, in the case, like the fourth embodiment shown in FIG. 7, where the insulating layer 63 is formed on the surface of the metal heat transfer plate 55 by the surface treatment, as compared with the resin coating layer 52A (see FIG. 4) formed by synthetic resin material, this case (the fourth embodiment) has excellent heat transfer. Also, in this case (the fourth embodiment), it is possible to obtain a thin (more specifically, less than 1μm) and even layer, then high insulation performance and high heat transfer can be realized.

Especially in the case, like the present embodiment, where the aluminium oxide coating as the insulating layer 63 is provided on the surface of the heat transfer plate 55 by the aluminium oxidation (the electrolysis or the anodic oxidation) process, a level or a degree of flatness (or evenness) of the surface of the heat transfer plate 55 is increased. Hence, even if an uneven spot or an acute projection exists on the surface of the heat transfer plate 55 before carrying out the surface treatment, by increasing the degree of flatness by the aluminium oxidation, the heat transfer can be increased while suppressing a thermal resistance. Also, appearance of the uneven spot or the acute projection on the surface can be suppressed, and it is possible to reduce a possibility that the current will pass through the heat transfer plate 55 and the silver electrode 52 due to an electric contact between the heat transfer plate 55 and the silver electrode 52.

Here, a forming area of the insulating layer 63 is not limited to the above embodiment. For example, the insulating layer 63 could be formed on all surfaces of the heat transfer plate 55. In this case, no masking process is required when carrying out the surface treatment, and thus manufacturing process becomes easy.

Or, the insulating layer 63A might be provided only at the side surface part of the inner side of the heat transfer plate 55 that is adjacent to or adjoins the silver electrode 52 and the temperature sensing element 51 through the adhesive layer 59, of the both side surfaces of the heat transfer plate 55, then the insulating layer 63B at the side surface part of an outer side of the heat transfer plate 55 is eliminated.

Or, it could be possible to form the insulating layer 63 only on the surface of the root portion 56, which is stuck or bonded to the adhesive layer 59, of the heat transfer plate 55, and to eliminate the insulating layer 63 at the bending portion 58 and the top end portion 57.

Further, regarding the surface treatment, it is not limited to the aluminium oxidation of the aluminum alloy heat transfer plate 55 as described in the above embodiment. Other oxidation coating processes of the heat transfer plate 55 that is formed by other metal material could be possible.

In addition, in the above embodiments, the sensor unit 41 having, as the canister sensor, the heat capacity sensor 40A and the temperature sensor 40B for the temperature compensation is fixed to the casing 11 of the canister. However, in a simple manner, the canister sensors 40 could be separately fixed to the casing 11 of the canister.

Additionally, as a fixing manner of the sensor to the casing 11, in a simpler manner, the sensor might be fixed by welding the sensor or its fixing bracket to the side wall.

1-8. (canceled)

9. A sensing device for a canister whose casing is filled with an adsorbent to adsorb an evaporated fuel, the sensing device comprising:
a canister sensor that detects a state of the adsorbent filling an inside of the casing of the canister, the canister sensor having
a temperature sensing element;
a current application unit that applies current to the temperature sensing element;
a non-conductive insulating material that covers peripheries of the temperature sensing element and the current application unit which are arranged in the casing; and
a heat transfer plate having a heat conductivity that is higher than at least that of the insulating material, and wherein
a root portion, which is covered in the insulating material, of one end side of the heat transfer plate is arranged with the root portion being adjacent to the temperature sensing element, and
a top end portion, which protrudes from the insulating material, of the other end side of the heat transfer plate is exposed to the inside of the casing filled with the adsorbent.

10. The sensing device for the canister as claimed in claim 9, wherein:
a pair of the heat transfer plates are provided so as to sandwich the temperature sensing element, and
a space between a pair of the top end portions, which are exposed to the inside of the casing, of the heat transfer plates is wide as compared with that of the root portion.

11. The sensing device for the canister as claimed in claim 9, wherein:
the heat transfer plate is provided with at least one of a plurality of penetration holes and a plurality of uneven parts.

12. The sensing device for the canister as claimed in claim 9, wherein:
a sensor unit having, as the canister sensor, a heat capacity sensor that detects a heat capacity of the adsorbent and a temperature sensor that detects a temperature is fixed to a side wall of the casing of the canister,
the heat capacity of the adsorbent is detected on the basis of an output voltage or an output current of the temperature sensing element in a state in which the temperature sensing element of the heat capacity sensor is heated by the current application, and the heat capacity is corrected according to the temperature detected by the temperature sensor, and
in order that a temperature increase, due to the heat generation, of the heat capacity sensor is not detected by the temperature sensor, a predetermined space is secured between the heat transfer plate of the heat capacity sensor and the heat transfer plate of the temperature sensor.

13. The sensing device for the canister as claimed in claim 9, wherein:
the heat transfer plate is formed by metal material, and
an insulating layer is formed at least on a surface of the root portion of the metal heat transfer plate by surface treatment.

14. An NTC ceramic element that is used as the temperature sensing element of the canister sensor as claimed in claim 9, and has such negative characteristic that a resistance of the element decreases with increase of a temperature.

15. The NTC ceramic element as claimed in claim 14, wherein:
B constant (B_{25/85}) of the NTC ceramic element is 3500˜5500 K (Kelvin).

16. A canister sensor detecting a state of an adsorbent that adsorbs an evaporated fuel filled in a casing of a canister, comprising:
a temperature sensing element;
a current application unit that applies current to the temperature sensing element;
a non-conductive insulating material that covers peripheries of the temperature sensing element and the current application unit which are arranged in the casing; and
a heat transfer plate having a heat conductivity that is higher than at least that of the insulating material, and wherein
a root portion, which is covered in the insulating material, of one end side of the heat transfer plate is arranged with the root portion being adjacent to the temperature sensing element, and
a top end portion, which protrudes from the insulating material, of the other end side of the heat transfer plate is exposed to an inside of the casing filled with the adsorbent.
